(19) United States
(12) Patent Application Publication
(10) Pub. No.: US 2010/0291935 A1
(43) Pub. Date: Nov. 18, 2010

(54) Multi-stream wireless relay

(76) Inventors: Ashok N. Rudrapatna, Basking Ridge, NJ (US); Kathiravetpillai Sivanesan, Richardson, TX (US); Subramanian Vasudevan, Morristown, NJ (US)

Correspondence Address: Docket Administrator;( Room 2F-192), Alcatel Lucent 600, Mountain Avenue, Murray Hill, NJ, 07974-0636, US

(21) Appl. No.: 12/459,341

(22) Filed: Jun. 30, 2009

Related U.S. Application Data
(60) Provisional application No. 61/216,316, filed on May 15, 2009.

(51) Int. Cl. H04W 72/00; H04B 7/14

(52) U.S. Cl. 455/450; 455/7

(57) ABSTRACT

A multi-stream wireless relay is arranged to maintain independent data streams with multiple base stations and thereby provide a relay from those multiple base stations to mobile units having respective communication relationships with those multiple base stations. In an alternative approach, the data streams from the multiple base stations are superposed on each other, wherein harmful inter-cell interference is converted into useful information bearing signals, thereby enabling the scheduling of transmission resources from the multiple base stations for a single mobile unit via the relay.

### RELATED APPLICATIONS

This application claims priority pursuant to 35 U.S.C. Sec 119(e) to U.S. Provisional Application No. 61/216,316, filed May 15, 2009, entitled “MULTI-STREAM WIRELESS RELAY,” the subject matter thereof being fully incorporated herein by reference.

This application is related to U.S. patent application Ser. No. 12/455,215, filed May 30, 2009, entitled “SYSTEM AND METHOD FOR CELL EDGE PERFORMANCE MANAGEMENT IN WIRELESS SYSTEMS USING DISTRIBUTED SCHEDULING” which is assigned to the same assignee and is incorporated herein by reference.

### FIELD OF THE INVENTION

The present invention generally relates to wireless relays.

### BACKGROUND OF THE INVENTION

Wireless relays typically operate to relay (or retransmit) RF signals between a base station and a user terminal apparatus such as a mobile phone or other mobile station, generally for purposes of broadening the area within which the user terminal apparatus can be used. Existing relay solutions for both coverage hole-filling and hot spot, however, communicate with only a single base station. In the case of two or more relays connected to different base stations that are near a common cell border, using the same frequency carriers, the resulting inter-cell, inter-relay interference reduces the efficiency of the system.

### SUMMARY OF INVENTION

An embodiment of the present invention provides a wireless relay that is arranged to maintain independent data streams with multiple base stations and thereby providing a relay from those multiple base stations to mobile units having respective communication relationships with those multiple base stations. In a further embodiment of the invention, when the data streams from the multiple base stations are superposed on each other, harmful inter-cell interference is converted into useful information bearing signals (or, alternatively nullifying the effect of such interference) thereby improving the efficiency of the transmission from the multiple base stations for one or more single mobile units via the relay. In that further embodiment, a successive interference canceller or spatial multiplexing receiver (e.g., minimum mean square error (MMSE), Maximum likelihood (ML) based receiver) is provided at the wireless relay, with or without superposition coding, which functions to achieve a multi-user channel capacity.

Thus, multiple interfering relays which are each only connected to one serving base station near a cell edge can, according to embodiments of the invention, be consolidated into a single multi-stream capable wireless relay communicating with the multiple surrounding base stations. The resource assignment for the communications link between the wireless relay and a served mobile station (also sometimes referred to herein as a user equipment (UE)) is either orthogonal to a direct link provided between the serving base station and the served mobile station or uses common resource sharing. Route selection for a given communication, as between the direct base-station to mobile link and the link via the wireless relay, is made by creating a spectral efficiency metric for the combined base station to wireless relay link and the wireless relay to mobile station link, and comparing that with the spectral efficiency achievable on a direct link between the serving base station and the served mobile station.

### BRIEF DESCRIPTION OF THE FIGURES

The teachings of the present invention can be readily understood by considering the following detailed description in conjunction with the accompanying drawings, in which:

FIG. 1 schematically depicts a plurality of wireless cells configured to implement the methodology of the invention.

FIG. 2 schematically depicts inter-nodal connections and resource assignment approaches according to the invention methodology.

FIG. 3 schematically depicts another example deployment of multi-stream relays according to the invention.

FIG. 4 schematically depicts yet another example deployment of multi-stream relays according to the invention.

FIG. 5 depicts performance results achievable with the methodology of the invention.

FIG. 6 depicts additional performance results achievable with the methodology of the invention.

FIG. 7 depicts further performance results achievable with the methodology of the invention.

### DETAILED DESCRIPTION

In the following description, for purposes of explanation and not limitation, specific details are set forth such as particular architectures, interfaces, techniques, etc., in order to provide a thorough understanding of illustrative embodiments of the invention. However, it will be apparent to those skilled in the art that the invention may be practiced in other illustrative embodiments that depart from these specific details. In some instances, detailed descriptions of well-known devices, circuits, and methods are omitted so as not to obscure the description of described embodiments with unnecessary detail. All principles, aspects, and embodiments, as well as specific examples thereof, are intended to encompass both structural and functional equivalents thereof. Additionally, it is intended that such equivalents include both currently known equivalents as well as equivalents developed in the future.

The inventors disclose herein a new methodology for operating a wireless relay to support improved communication in a wireless system. Specifically, the inventors provide, and disclose herein, a multi-stream wireless relay that maintains substantially independent communications links with multiple base stations, typically at or near a cell edge location.

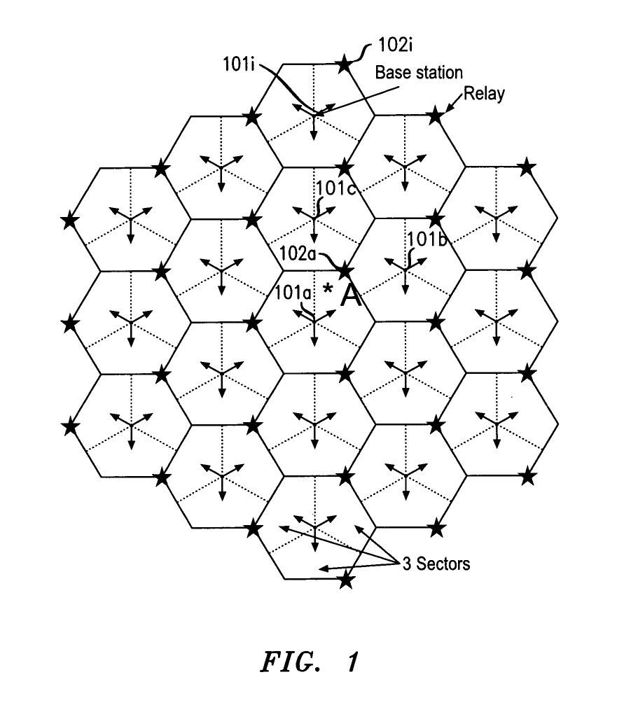

An illustrative embodiment of a method for implementing a multi-stream wireless relay according to the invention is illustrated in FIG. 1. In that figure, which generally depicts a plurality of adjacent wireless cells comprising (or forming a portion of) a wireless communications system, each cell is depicted as having a hexagonal boundary with a base station 101 at its center. A plurality or omni relays are depicted in the figure, each by a star symbol 102, at various cell-edge locations. Each cell is also illustrated as being divided into three sectors, as is common in the present art, although it should be clear that neither the sector division, per se, nor the number of sectors used, is critical to operation of the method of the invention. Accordingly, the methodology of the invention would be equally applicable to non-sectorized cells.

Consider now, with reference to FIG. 1, a need for communication with one or more mobile stations located near the point “A” of that figure. To that end, a transmission needs to be initiated for at least one such mobile station, and it is understood that in normal operation a relay in the transmission path is transparent to the mobile station. Upon transmission of a pilot signal or the like, the mobile station measures the channel quality of signals from the base stations and/or relays from which usable signals are received (e.g., base stations 101a and 101c , and possibly 101b , along with relay 102a ), and reports respective channel quality indicators (CQI) via the respective reverse control channels to all serving base stations and relays. The serving base stations and relay receive the CQI directly from the mobile.

Based on the received CQI from the mobile station, the relay decides whether the mobile is servable via the relay. If it is servable, the relay reports the received CQI from the mobile station, along with the mobile's identification, to each of the multi streaming base stations with which it is linked, via the reverse link control channels between the relay and those multi-streaming base stations—illustratively between relay 102a and base stations 101a and 101c.

The number of base stations which are multi streaming to a particular relay may be set periodically in reasonable time intervals. The relay also periodically measures the CQI of the channels from the surrounding base stations and reports them to the multi-streaming set of base stations. Alternatively, the relay may report these measurements to the mobile station, along with the CQI received from the mobile station.

The base stations receive the CQIs for the base station-mobile, relay-mobile, and base station-relay links and make scheduling (resource assignment) decisions based on them. That resource assignment operation by the multi-streaming base stations is described more fully below.

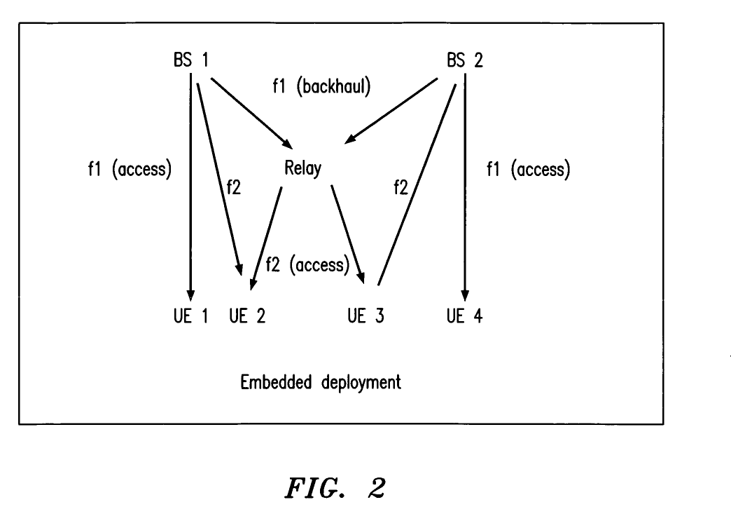

FIG. 2 shows the basic frequency assignment approach for an embedded relay deployment scenario—frequency assignments being indicated by fᵢ reference designators shown adjacent specific links in the figure. An embedded deployment is one where a relay is situated between existing base stations. The coverage area of the relay overlaps with the pre-existing coverage of these base stations. These deployments are usually at traffic hot spots. The orthogonal frequency assignment approach employed here is dictated by interference considerations. More specifically, it is necessary for the relay to transmit to mobile stations at a frequency (or set of frequencies) that is different from the frequency at which the surrounding base stations transmit to the users directly served by them. If the same frequencies are used, the interference from the surrounding base stations causes a substantial degradation of the signal intended for the mobile station(s) served by the relay

In order maintain fairness, the base station uses the effective data rate for the mobile while prioritizing transmissions to it via the relay. A preferred resource assignment approach for use with the multistream relay of the invention is described below.

A mobile unit has the option of either communicating directly with a base station or via the relay, assuming a usable communications link can be established directly with the base station by the mobile unit. The route selection principles for choosing between a direct mobile-to-base-station link and a link via the relay for the multi-stream relay deployment of the invention are illustrated for a single base-station to mobile case (via either the relay or a direct link) but can readily be extended to the the multi-stream relay case.

Consider then the case first where the relay is receiving data from the same (and only one) base station as the mobile unit. The signal to noise ratio experienced by transmissions on each of these links—base station to relay, relay to mobile, and base station to mobile—are SNR_{br}, SNRᵣᵤ, and SNR_{bu} where the subscripts b, r, and u denote base station (eNodeB), relay node and user (mobile unit) respectively.

In systems of the current art, the mobile station usually reports the rate that can be supported by it based on the SNR of the link from the base station to it.

R_{bu}=log(1+SNR_{bu})

The legs along the relay route support R_{br} and R_{bu} which can similarly be derived from the respective link-SNRs.

The aggregate time taken for data transport along the relay route for a payload B is:

T_{bru}=B/R_{br}+B/Rᵣᵤ

Thus, recognizing R_{bru}=B/T_{bru}

1/R_{bru}=1/R_{br}+1/Rᵣᵤ

Accordingly, the harmonic mean HM(R_{br}, Rᵣᵤ) is compared with the direct path R_{bu} to select between these two routes The route selection can be made at the mobile, the relay, the base station or some other network element assuming the means to deliver the relevant input information to that element.

In the case of the multi-stream relay, the R_{br}=R_{mbr} is simply the aggregate multiple-base station-to-relay rate that can be supported between the multiple base stations serving the relay. This rate is used in the route selection procedure described above. Accordingly, the harmonic mean HM(R_{mbr}, Rᵣᵤ) is compared with the direct path R_{bu} to select between these two routes

Bandwidth splitting for orthogonal resource assignment is carried out as follows. The bandwidth split may be done in two ways. The simplest one is static bandwidth splitting. In static splitting the bandwidth for the relay-mobile and relay-base station links are predetermined. Alternatively, bandwidth can be split dynamically between the base stations-relay and relay-mobile links.

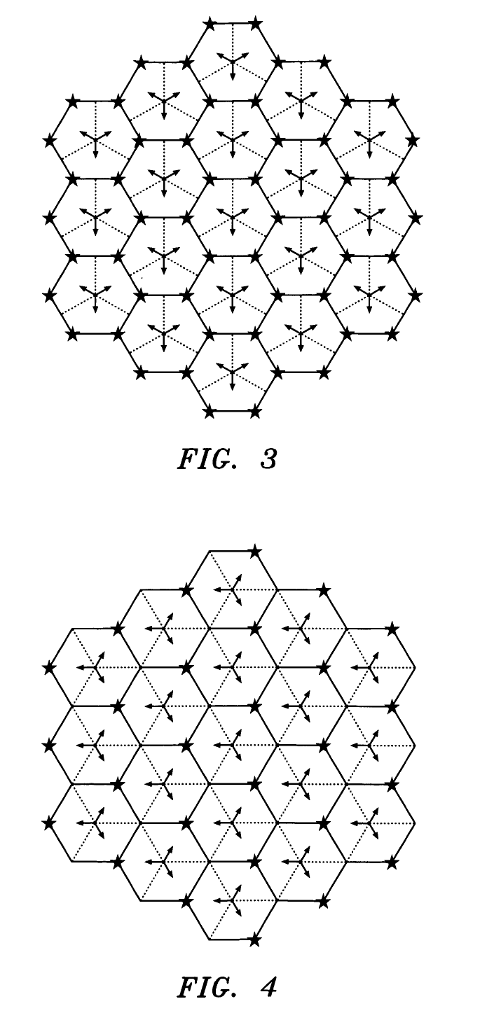

The heretofore description of the multi-stream wireless relay of the invention has been focused on the relay deployment shown illustratively in FIG. 1. It should, however, be understood that the principles of the invention apply equally to other relay configures, and to more or less than the number of relays shown in FIG. 1. For example, in FIG. 3, relays are shown deployed at every point of sector intersection in the depicted wireless system, and each relay will be applied in exactly the same way as previously described. Similarly, FIG. 4 shows a relay deployment where the relays are only located at sector edges in alignment with the center of the antenna transmission pattern for the sector. Numerous other relay deployment scenarios for the multi-stream relay methodology of the invention will be apparent to those skilled in the art, and all are within the contemplation of the invention scope.

While the foregoing description has been focused on the operation generally of the multi-stream relay methodology of the invention, a particularly advantageous embodiment of the invention occurs when the multi-stream relay operates to receive signals from the multiple base stations that are directed to one or more single mobile units—i.e., distributed scheduling of information for ones of the single mobile units, via the relay, from the multiple base stations. Operation of that embodiment is described below.

In general, the concept of distributed scheduling from multiple base stations to a single mobile unit is disclosed and described in the cross referenced related application, U.S. patent application Ser. No. 12/455,215. Inasmuch as the content of that application has been incorporated by reference, details of that approach will not be repeated here. Suffice to note that, as taught be the cross-referenced application, through application of an interference canceller at a receiving node—there the mobile unit, here the multi-stream relay—substantially concurrent transmissions from the multiple base stations can be processed at the receiving node without interference among the competing streams, resulting in a significant increase in throughput for the overall transmission path.

As all the rate-request and channel quality information from the receiving node required for the distributed scheduling is transmitted to all multi streaming base stations, they replicate the other base station scheduling functions/decisions on their own.

Assume that the schedulers at each of the base stations use a proportional fair scheduler. This scheduler creates a priority metric for each user that is served by it directly or via the relay. When multi streaming by two or more base stations to the relay, the scheduler in each base station will make inferences about the rate at which the relay has been served at the other base station(s). By doing so, each scheduler is using the correct fairness metric for the handoff users and will therefore free up scheduling opportunities for users not in handoff thereby increasing sector throughput.

As shown heretofore, according to the invention, a wireless relay that concurrently transmits data to and receives data from multiple wired base stations is placed at an advantageous location with respect to each of these base stations and thus improves coverage for mobile users in areas distant from those base station sites. The relay may employ successive interference cancellation or other advanced receiver techniques to maximize received throughput from the multiplicity of base stations.

The system supports route selection either by the mobile user or by the network to maximize system performance. The scheduling mechanism at the base station is able to be fair to both mobiles served directly by it as well served by it via the relay.

While a representative backwards-compatible multi-stream omni relay deployment was described and illustrated in conjunction with FIGS. 1-4, it is contemplated that, in advanced deployments, the mobiles may also have the capability of multi-streaming from surrounding base stations and relays.

The multi-stream relay deployment of the invention has several advantages over the conventional relay deployment in which the relays only communicate with one serving base station. Among those advantages are:
1. In the conventional deployment each sector has its own relay(s) while, with the disclosed invention, the relays are shared by the surrounding sectors. In other words a relay may be able serve all surrounding sectors. Thus, there will be fewer relays in a particular serving area in the disclosed relay deployment. It will reduce the harmful other-cell (co-channel) interference as well as the initial deployment cost.
2. In the disclosed relay deployment, the relays are communicating with several surrounding sectors/ base stations. Thus, the harmful interference signals from those surrounding sectors/base stations in the conventional deployment are intelligently used to carry the useful data.
3. In a “hotspot” scenario, use of the relay deployment of the invention enables a sharing of the backhaul transmission for the relay among several surrounding sectors/base stations. Thus, it does not burden one base station and the network capacity may be higher in the hotspot.

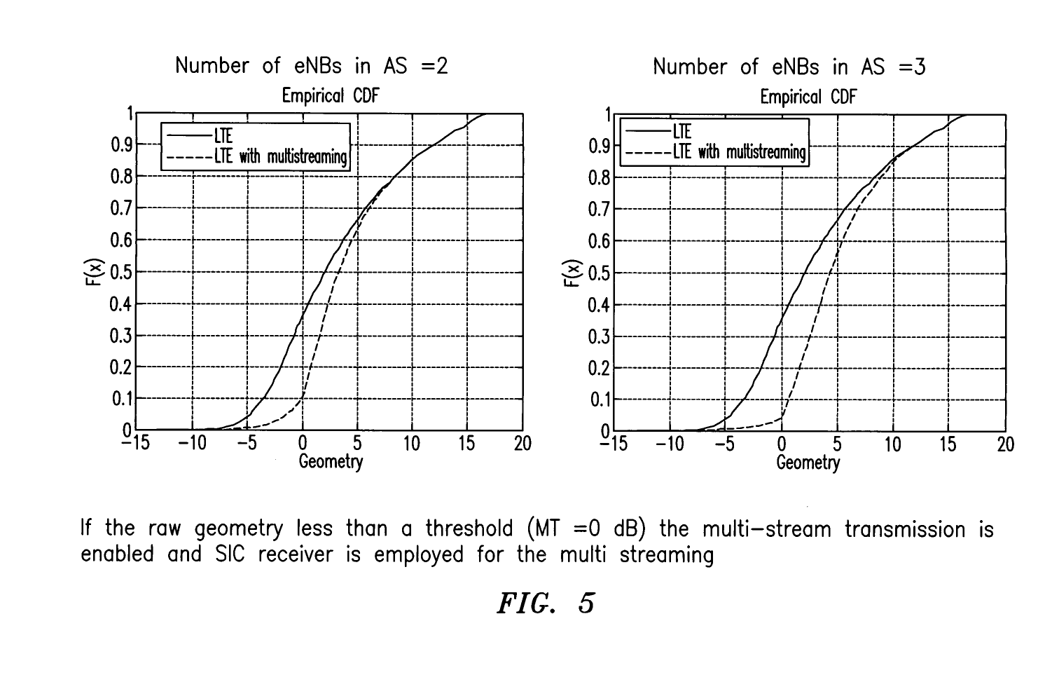

The inventors have demonstrated, through simulation, that a performance gain is clearly obtained by the use of multi-stream mobiles over single-stream mobiles for the conventional cell configuration. Consider, for example, a multi-stream relay deployment case of t relays at the cell edge. Without use of the multi streaming capability the geometry which is the longterm average signal-to-noise plus interference power ratio is at 10% of the raw geometry cumulative distribution function (CDF), while the equivalent geometry jumps to 40% of raw geometry CDF with multi streaming for the relay. Thus the multi streaming relay of the invention gives a clear network capacity gain for serving the mobiles in its proximity, as illustrated in FIG. 5.

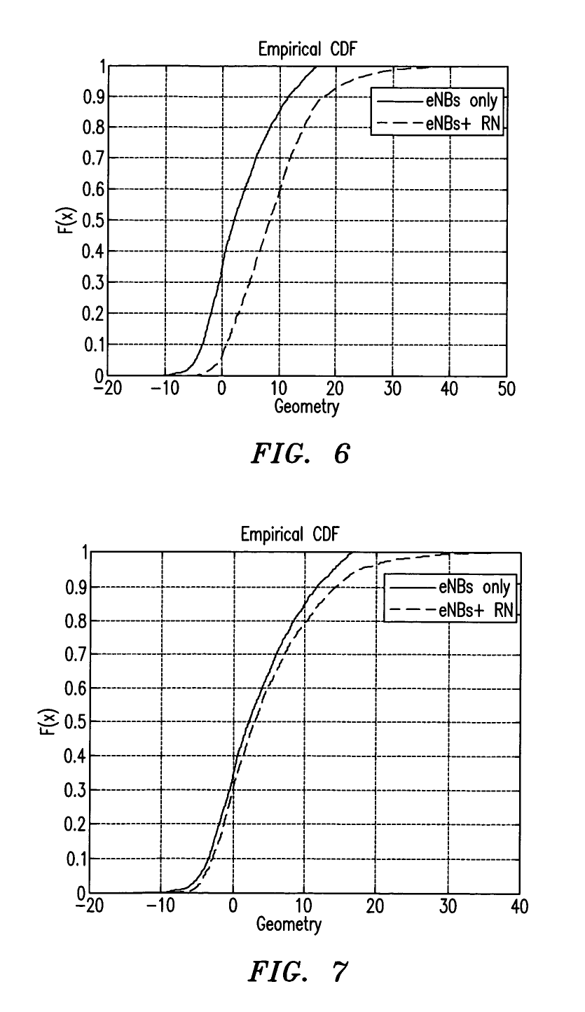

As a further performance indicia, the geometry distribution of the mobile users in FIG. 1 with and without relays is depicted in FIG. 6. The base stations and relays use orthogonal resources for transmission and the relays are omni-directional. The results show that the geometry gain is substantial and it is around 5 dB in the operating geometry range.

Similarly, FIG. 7 depicts the geometry distribution with the same resources for the base station and relay transmission. In this case, there is still a geometry gain around 0.5-1.0 dB. This deployment scenario could be used for coverage extension situations.

Herein, the inventors have disclosed a method and system for providing improved data throughput in a wireless communication system using multi-stream relay methodologies. Numerous modifications and alternative embodiments of the invention will be apparent to those skilled in the art in view of the foregoing description.

Accordingly, this description is to be construed as illustrative only and is for the purpose of teaching those skilled in the art the best mode of carrying out the invention and is not intended to illustrate all possible forms thereof. It is also understood that the words used are words of description, rather that limitation, and that details of the structure may be varied substantially without departing from the spirit of the invention, and that the exclusive use of all modifications which come within the scope of the appended claims is reserved.

We claim

1. A method for wireless communication comprising:
establishing a wireless relay at a location proximate to a plurality of base stations;
receiving signals at the wireless relay from the at least two of the plurality of base stations retransmitting by the wireless relay of the received signals to at least one mobile station.

2. The method of claim 1 wherein the signals received at the wireless relay from the at least two base stations are retransmitted to at least two mobile stations.

3. The method of claim 1 wherein the signals received at the wireless relay were transmitted in superposition from the at least two base stations

4. The method of claim 3 wherein the wireless relay implements interference cancellation for the superpositioned signals transmitted from the at least two base stations.

5. The method of claim 3 wherein the superpositioned signals transmitted from the at least two base stations constitute data signals for retransmission by the relay to at least one single mobile station.

6. The method of claim 1 wherein ones of the at least two base stations are operative to transmit a signal to a given mobile station via the wireless relay or via a direct connection with the mobile station.

7. The method of claim 6 wherein frequency assignments for a communications link between the wireless relay and the given mobile station is substantially orthogonal to the frequency assignment for the direct connection between the base station and the given mobile station.

8. The method of claim 6 wherein a communications link between the wireless relay and the given mobile station and the direct connection between the base station and the given mobile station share a common frequency assignment.

9. The method of claim 6 wherein route selection between the direct connection between the base station and the given mobile station and the connection via the wireless relay is made as a function of spectral efficiency on the alternate routes.

10. The method of claim 9 further wherein a spectral efficiency metric is determined for the direct connection route and for the relay connection route, and route selection is made based on a comparison of those spectral efficiency metrics.

11. A wireless relay comprising:
means for concurrently receiving communication streams from multiple base stations; and
means for processing the concurrently received communication streams for retransmission to at least one mobile station.

12. The wireless relay of claim 11 further comprising means for interference cancellation among the received communication streams.
